(19) United States
(12) Patent Application Publication
(10) Pub. No.: US 2025/0348257 A1
(43) Pub. Date: Nov. 13, 2025

(54) STORAGE MEDIUM, CONTROL METHOD FOR INFORMATION PROCESSING APPARATUS, AND INFORMATION PROCESSING APPARATUS

(71) Applicant: CANON KABUSHIKI KAISHA, Tokyo (JP)

(72) Inventor: SHU KUMAHASHI, Ibaraki (JP)

(21) Appl. No.: 19/202,788

(22) Filed: May 8, 2025

(30) Foreign Application Priority Data
May 13, 2024 (JP) 2024-077930

(51) Int. Cl. G06F 3/12; H04N 1/00

(52) U.S. Cl. CPC G06F 3/1253; G06F 3/126; G06F 3/1288; G06F 3/1293; H04N 1/00212

(57) ABSTRACT

A non-transitory computer-readable storage medium for storing a program for causing a computer of an information processing apparatus to perform an information processing method, the method includes receiving a print instruction using a chat function, obtaining a print setting registered by a printer driver included in the information processing apparatus, and causing a printing apparatus to perform printing based on the print setting according to the print instruction.

### BACKGROUND

### Field

The present disclosure relates to a storage medium, a control method for an information processing apparatus, and an information processing apparatus.

### Description of the Related Art

Japanese Patent Application Laid-Open No. 2018-128843 discusses an information processing system capable of printing, using a software robot (bot), a document stored in a cloud server according to a print instruction in a chat format received from a user. Japanese Patent Application Laid-Open No. 2018-128843 also discusses a technique in which the bot sends an inquiry about print settings to the user on a chat and the user replies to the inquiry, thereby determining print settings.

Use cases may include a case where software (or an application) for creating or changing documents cooperates with an artificial intelligence (AI) to execute printing according to a print instruction in a chat format from a user.

Users can typically make and register frequently used print settings as a preset with a printer driver. However, the technique discussed in Japanese Patent Application Laid-Open No. 2018-128843 does not use any print settings made with a printer driver, which makes it difficult for the user to use print settings registered as a preset when the user issues a print instruction in a chat format. In other words, although the user has registered print settings as a preset using a printer driver, the user cannot use the print settings, and the user needs to make print settings in a chat format when the user issues a print instruction. It takes time and effort to make print settings.

### SUMMARY

The present disclosure has been made in view of the above-described issues and is directed to reducing time and effort for a user to make print settings when the user issues a print instruction in a chat format.

According to an aspect of the present disclosure, a non-transitory computer-readable storage medium for storing a program for causing a computer of an information processing apparatus to perform an information processing method, the method includes receiving a print instruction using a chat function, obtaining a print setting registered by a printer driver included in the information processing apparatus, and causing a printing apparatus to perform printing based on the print setting according to the print instruction.

Further features of the present disclosure will become apparent from the following description of exemplary embodiments with reference to the attached drawings.

### BRIEF DESCRIPTION OF THE DRAWINGS

FIG. 1 illustrates an example of an overall configuration of a system according to a first exemplary embodiment.

FIG. 2 is a block diagram illustrating a hardware configuration example of an image forming apparatus.

FIG. 3 is a block diagram illustrating a hardware configuration example of an information processing terminal.

FIG. 4 is a block diagram illustrating a hardware configuration example of an artificial intelligence (AI) server.

FIG. 5 is a block diagram illustrating a hardware configuration example of an extension application server.

FIG. 6 is a block diagram illustrating a hardware configuration example of a cloud print server.

FIG. 7 is a block diagram illustrating a software configuration example of the information processing terminal.

FIG. 8 illustrates a screen to be displayed when a business application instructs the image forming apparatus to execute printing.

FIG. 9 illustrates a screen for selecting a printer to be used for printing with the business application.

FIG. 10 illustrates a screen for making print settings with the business application.

FIG. 11 is a sequence diagram according to the first exemplary embodiment.

FIG. 12 is a flowchart for the extension application server according to the first exemplary embodiment.

FIG. 13 is a sequence diagram according to a second exemplary embodiment.

FIG. 14 is a block diagram illustrating a hardware configuration example of a job generation server.

FIG. 15 is a sequence diagram according to a third exemplary embodiment.

FIG. 16 illustrates an example of processing to be performed by an AI server business application plug-in according to the first exemplary embodiment.

### DESCRIPTION OF THE EMBODIMENTS

Exemplary embodiments of the present disclosure will be described in detail below with reference to the drawings. Each of the embodiments of the present disclosure described below can be implemented solely or as a combination of a plurality of the embodiments or features thereof where necessary or where the combination of elements or features from individual embodiments in a single embodiment is beneficial.

The following exemplary embodiments are not intended to limit the disclosure, and not all combinations of features described in the exemplary embodiments are necessarily deemed to be essential.

A first exemplary embodiment of the present disclosure will now be described.

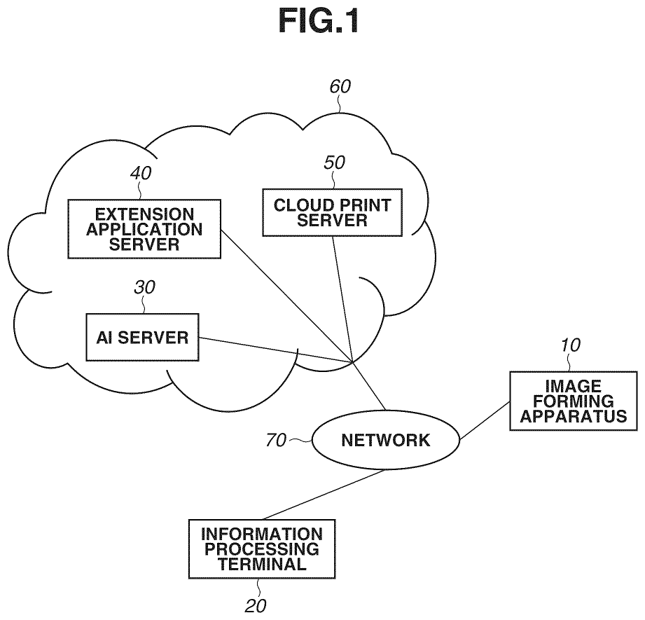

FIG. 1 illustrates an example of an overall configuration of an artificial intelligence (AI) print service according to the present disclosure. The AI print service includes an image forming apparatus 10 serving as an example of an image processing apparatus, an information processing terminal 20 serving as an example of an information processing apparatus, an AI server 30, an extension application server 40, and a cloud print server 50, which are communicably connected to each other via a network 70. The network 70 is a wireless or wired network such as a wide area network (WAN) or a local area network (LAN).

The image forming apparatus 10 is an image forming apparatus having a function for printing data such as images transmitted from the cloud print server 50 on a print medium. The image forming apparatus 10 is an example of a printing apparatus.

The information processing terminal 20 is an information processing apparatus or an information terminal, such as a smartphone, a tablet terminal, or a personal computer (PC), which is used by a user of the AI print service. The user operates the information processing terminal 20 to use a business application to be described below. The information processing terminal 20 and the AI server 30 are each connected to a wired or wireless communication network so that the information processing terminal 20 and the AI server 30 can transmit and receive data. The first exemplary embodiment assumes a case where a public line on the Internet is used as an example of the communication network. Alternatively, a privately leased line can also be used.

The AI server 30 is a cloud server that is located on a cloud 60, and provides services in cooperation with the extension application server 40. The AI server 30 interprets a message transmitted from an AI server business application plug-in 703 to be described below on the information processing terminal 20, thereby issuing an instruction to send an appropriate response and perform business support processing on the AI server business application plug-in 703. The AI server 30 can also extend the functions by communicating with the extension application server 40. The message received by the AI server 30 can be a message input using characters of a natural language used by a human. The AI server 30 interprets such a message.

The message received by the AI server 30 is referred to as a prompt.

The extension application server 40 is a cloud server located on the cloud 60, and is a service for providing the AI server 30 with an additional function. The AI server 30 cooperates with the extension application server 40, thereby making it possible to perform processing that cannot be performed alone. In the first exemplary embodiment, the extension application server 40 extends the functions to enable printing using an image forming apparatus.

The cloud print server 50 is configured to generate a print job upon receiving a print request from another information processing apparatus, and to input the print job to a registered image forming apparatus via the Internet. The cloud print server 50 and the AI server 30 cooperate with each other, and a business application 702 to be described below and the AI server business application plug-in 703 cooperate with each other based on user account information.

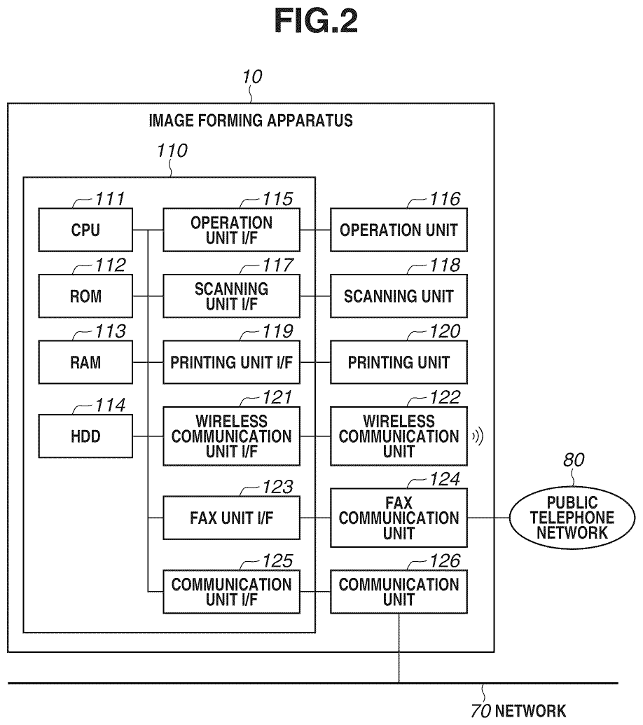

FIG. 2 is a block diagram illustrating a hardware configuration example of the image forming apparatus 10.

A control unit 110 including a central processing unit (CPU) 111 controls an overall operation of the image forming apparatus 10. The CPU 111 loads control programs stored in a read-only memory (ROM) 112 or a hard disk drive (HDD) 114 into a random access memory (RAM) 113 to perform various control processing such as scanning control processing and printing control processing.

The ROM 112 stores control programs that can be executed by the CPU 111. The ROM 112 also stores a boot program, font data, and the like. The RAM 113 is a main storage memory and is used as a temporary storage area for loading various control programs stored in a work area, the ROM 112 and the HDD 114. The HDD 114 stores image data, print data, various programs, various addresses, and various setting information. The HDD 114 is a storage medium. A solid-state drive (SSD), an embedded Multi Media Card (eMMC), or the like may be used instead of the HDD 114.

The image forming apparatus 10 according to the first exemplary embodiment is configured such that one CPU 111 executes processes illustrated in flowcharts to be described below using one memory (RAM 113). However, the configuration of the image forming apparatus 10 is not limited to this configuration. For example, the processes can be executed by causing a plurality of CPUs, RAMS, ROMs, and HDDs to operate in cooperation with each other. Alternatively, some of the processes can also be executed using a hardware circuit such as an application-specific integrated circuit (ASIC) or a field programmable gate array (FPGA).

An operation unit interface (I/F) 115 connects the control unit 110 and an operation unit 116 including hardware keys and a display unit such as a touch panel. The operation unit 116 is configured to display information for the user, or detect an input from the user.

A scanning unit I/F 117 connects the control unit 110 and a scanning unit 118. The scanning unit 118 scans an image on a document, and the CPU 111 converts the image into image data such as binary data. Image data generated based on the image scanned by the scanning unit 118 is transmitted to an external apparatus, or is printed on a print medium.

A printing unit I/F 119 connects the control unit 110 and a printing unit 120. The CPU 111 transfers image data (print data) stored in the RAM 113 to the printing unit 120 via the printing unit I/F 119. The printing unit 120 prints the image based on the transferred image data on a print medium fed from a sheet feed cassette.

A wireless communication unit I/F 121 is an I/F for controlling a wireless communication unit 122 and connects the control unit 110 and an external wireless apparatus via a wireless connection.

A facsimile (FAX) unit I/F 123 controls a FAX communication unit 124 to connect to a public telephone network 80. The FAX unit I/F 123 is an I/F for controlling the FAX communication unit 124 and is configured to control a modem for FAX communication or a network control unit (NCU), thereby enabling connection to the public telephone network 80, control of a FAX communication protocol, and the like.

A communication unit I/F 125 connects the control unit 110 and the network 70. The communication unit I/F 125 allows the communication unit 126 to transmit image data and various information in the image forming apparatus 10 to an external apparatus on the network 70 and to receive print data, print instructions, information on the network 70, and the like from the external apparatus on the network 70. Examples of a method for transmitting and receiving data via the network 70 include a method of transmitting and receiving data using an electronic mail (e-mail), and a method of transmitting a file using any other protocol (e.g., a file transfer protocol (FTP), server message block (SM B), or Web-based Distributed Authoring and Versioning (WebDAV)). In addition, image data and message data can also be transmitted or received via the network 70 by access from the information processing terminal 20 or the cloud print server 50 on the cloud 60 via Hypertext Transfer Protocol (HTTP) communication.

The information processing terminal 20 is configured to access the image forming apparatus 10 from a web browser of the information processing terminal 20 via the network 70 and to make various settings (remote user interface (UI) function) for the image forming apparatus 10.

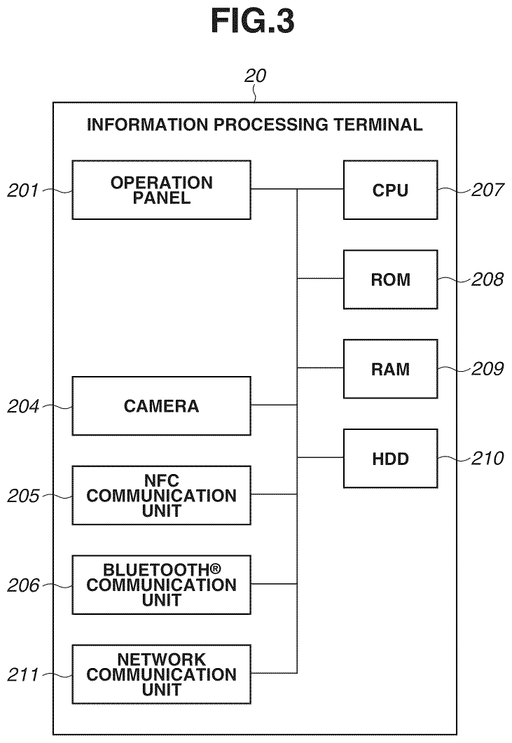

FIG. 3 is a block diagram illustrating a hardware configuration example of the information processing terminal 20. It is assumed that the information processing terminal 20 according to the first exemplary embodiment is an apparatus such as a PC, but instead can be any other information processing apparatus as long as the business application 702 can be installed on the apparatus and the apparatus can be connected to the network 70.

A CPU 207 reads out control programs stored in a ROM 208, and executes various processing for controlling the operation of the information processing terminal 20.

The ROM 208 stores control programs.

A RAM 209 is used as a main memory and a temporary storage area such as a work area for the CPU 207.

An HDD 210 stores various data such as photographs and electronic documents. Data described herein refers to data to be edited by the business application 702, data (print data) stored by the business application 702, and the like.

An operation panel 201 includes a touch panel function configured to detect a touch operation by the user, and displays various screens provided by an operating system (OS) or an e-mail transmission application. The operation panel 201 is also used to check information stored in the AI server 30. The user inputs a touch operation to the operation panel 201, thereby making it possible to input a desired operation instruction to the information processing terminal 20. The information processing terminal 20 includes hardware keys (not illustrated) and the user can input an operation instruction to the information processing terminal 20 using the hardware keys.

A camera 204 captures images according to an image capturing instruction from the user. Images captured by the camera 204 are stored in a predetermined area of the HDD 210. It is also possible to obtain information from a Quick Response (QR®) code scanned by the camera 204 using a program for QR® analysis.

The information processing terminal 20 exchanges data with various peripheral devices via a near field communication (NFC) communication unit 205, a Bluetooth® communication unit 206, or a network communication unit 211. The Bluetooth® communication unit 206 of the information processing terminal 20 can be configured to support Bluetooth® Low Energy.

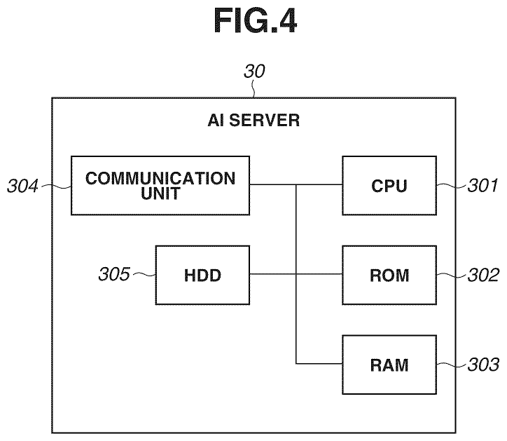

FIG. 4 is a block diagram illustrating a hardware configuration example of the AI server 30. A CPU 301 executes processing for controlling an operation of generating an appropriate response using a control program stored in a ROM 302 or a learning model stored in an HDD 305. The ROM 302 stores control programs. A RAM 303 is used as a main memory or a temporary storage area such as a work area for the CPU 301. The HDD 305 stores various data such as a learning model and an AI application. The AI server 30 can exchange data with various apparatuses such as the information processing terminal 20, the image forming apparatus 10, and the extension application server 40 via a communication unit 304. The communication unit 304 can establish wired communication using Ethernet®, or can establish wireless communication such as Wireless Fidelity (Wi-Fi®).

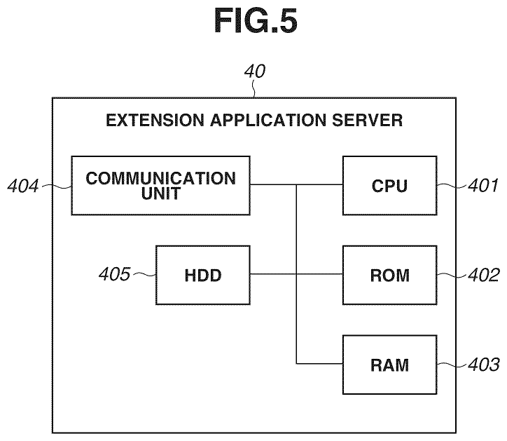

FIG. 5 illustrates a hardware configuration example of the extension application server 40. A CPU 401 reads out control programs stored in a ROM 402, and executes processing according to a message received from the AI server 30. The ROM 402 stores control programs. A RAM 403 is used as a main memory and a temporary storage area such as a work area for the CPU 401. An HDD 405 stores the contents of the message received from the AI server 30, a part of the contents, and the like. The extension application server 40 can transmit and receive data with apparatuses such as the AI server 30 via a communication unit 404.

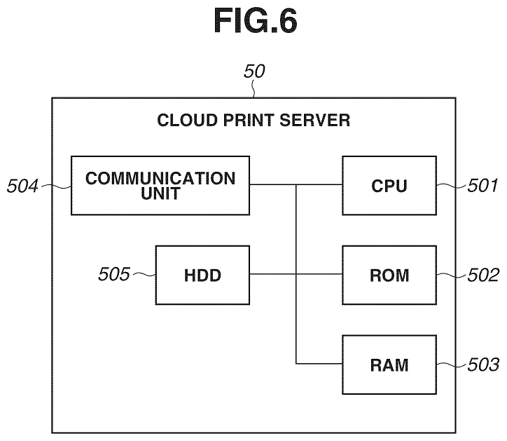

FIG. 6 is a block diagram illustrating a hardware configuration example of the cloud print server 50. A CPU 501 reads out control programs stored in a ROM 502, thereby making it possible to receive print jobs from the information processing terminal 20 and obtain stored print jobs. The ROM 502 stores control programs. A RAM 503 is used as a main memory and a temporary storage area such as a work area for the CPU 501. An HDD 505 stores print jobs and the like received from the information processing terminal 20. The cloud print server 50 can transmit and receive data with apparatuses such as the AI server 30 via a communication unit 504.

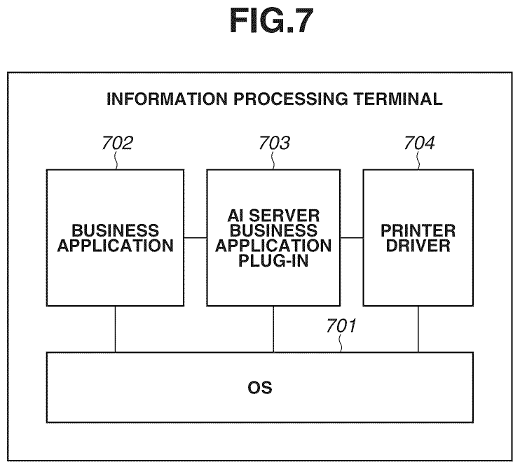

FIG. 7 is a block diagram illustrating a software configuration example of the information processing terminal 20. An OS 701 is an OS of the information processing terminal 20. Other applications provide interfaces for using hardware of the information processing terminal 20 and networks.

The business application 702 is software for, for example, creating documents and the like to be used for business. The AI server business application plug-in 703 belongs to the business application 702 and provides an interface for communicating with the AI server 30 so that the user can effectively operate the business application 702 using the AI server 30. The business application 702 and the AI server business application plug-in 703 log in using user account information to operate in cooperation with the cloud print server 50.

A printer driver 704 is software for controlling a printer from the information processing terminal 20. The printer driver 704 allows another application on the information processing terminal 20 to use the image forming apparatus 10. For example, the business application 702 can use the printer driver 704 in the case of printing a created document. The printer driver 704 receives setting information about the number of copies, a layout, and one-sided/double-sided printing, from the user. The printer driver 704 is configured to receive, from the user, frequently used values as default settings when the printer driver 704 is called (at start-up) by the business application 702, and to register the default settings in the HDD 210. Separately from the default settings, frequently used settings can be registered as a bookmark in the HDD 210 by the user using the printer driver 704. The settings registered as a bookmark are subsequently designated, called, and used by the user as print setting values for print data.

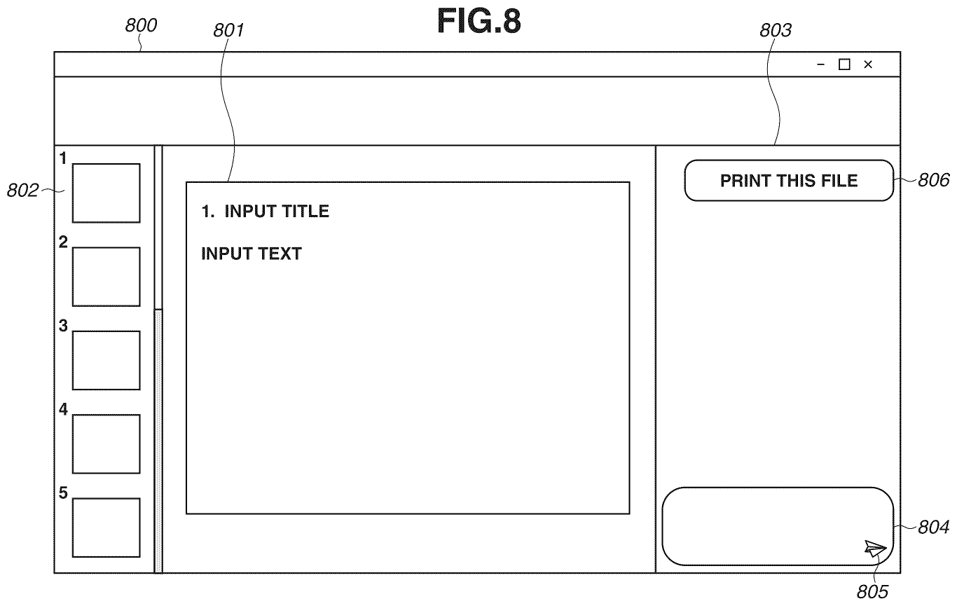

FIG. 8 illustrates a screen to be displayed when the business application 702 instructs the image forming apparatus 10 to print a document opened on the business application 702 by using the AI server business application plug-in 703, the AI server 30, and the extension application server 40. Examples of the business application 702 include, for example, presentation software for creating presentation materials, a document creation application for creating documents, and an image editing application for editing image data. In the first exemplary embodiment, presentation software is described as an example of the business application 702. The business application 702 has a chat function, and a chat area 803 is displayed by executing an application program of the business application 702.

A business application window 800 is an overall window to be displayed on the operation panel 201 of the information processing terminal 20 by the business application 702.

A slide editing area 801 is an area for displaying and editing an optional slide in the document currently opened on the business application 702.

A slide selection area 802 is an area for displaying thumbnails of a plurality of slides included in the document opened on the business application 702. The slide to be displayed on the slide editing area 801 can be switched by selecting a thumbnail of an optional slide.

The chat area 803 is an interactive exchange area for the user and the AI server 30. An AI server business application prompt input area 804 and a prompt transmission button 805, which are described below, are constantly displayed, and prompts input by the user and responses to the prompts from the AI server 30 are sequentially displayed. The chat area 803 may be displayed when the business application 702 is started, or may be displayed when a specific instruction is input. The chat area 803 and the business application 702 may be displayed side by side within one window. The chat area 803 can be displayed on another window, such as a pop-up window, separately from the business application 702.

The AI server business application prompt input area 804 enables the user to input an instruction using characters of a natural language to the AI server 30.

When the prompt transmission button 805 is pressed, the instruction input to the AI server business application prompt input area 804 is transmitted to the AI server 30.

A print start prompt 806 is a message in a chat format transmitted to the AI server 30. Specifically, the print start prompt 806 is a prompt (message) to be displayed when the user presses the prompt transmission button 805 after inputting a text “print this file” to the AI server business application prompt input area 804. A text input by the user is displayed as a prompt on the chat area 803. The text input to the AI server business application prompt input area 804 by the user is displayed on the chat area 803 and is transmitted to the AI server 30 when the prompt transmission button 805 is pressed. The prompt input by the user is not limited to a print instruction input using characters of a natural language, such as the text “print this file”. For example, a command or a keyword for instructing to execute printing can also be input. The prompt input by the user can also include print setting information and information for designating a printing apparatus.

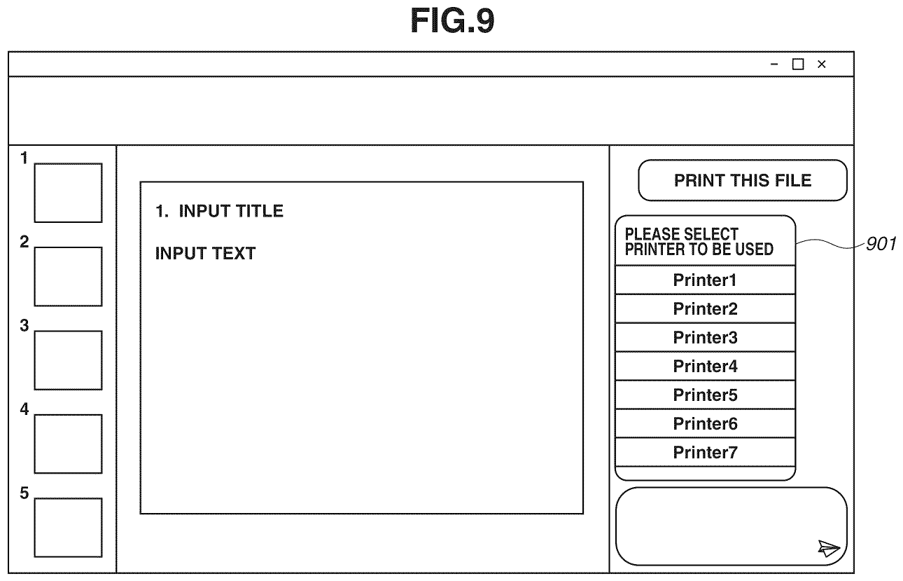

FIG. 9 illustrates a screen on which the display is changed according to a response from the AI server 30 after the screen illustrated in FIG. 8 is displayed. Descriptions of components illustrated in FIG. 9 that are identical to those illustrated in FIG. 8 are omitted.

A printer selection list box 901 is displayed by the AI server business application plug-in 703 as a list of printers that can be selected by the user. This list of printers is obtained by the business application 702 as a result of searching for printers that can be used by the information processing terminal 20 on the network 70 via the OS 701.

The printer selection list box 901 is a list box to be generated after the AI server 30 and the extension application server 40 interpret the text input by the user as a print start instruction. The user can select a printer to be used for printing from the displayed list box. When an arbitrary option on the screen is pressed, the selection result is automatically transmitted to the AI server 30. An enter button (not illustrated) can be provided and the enter button can be pressed after the user selects a printer, to thereby enter the selection and transmit the selection result to the AI server 30. The user that has viewed the list can directly input information about the printer to be used for printing among the printers displayed on the list box to the AI server business application prompt input area 804, and the content of a response can be transmitted to the AI server 30.

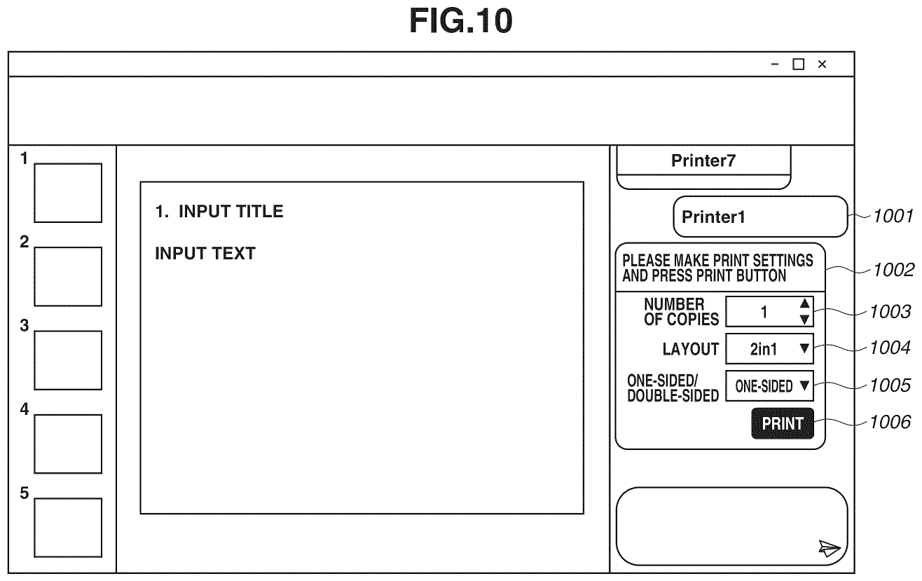

FIG. 10 illustrates a screen on which the display is changed by the user pressing “Printer1 (referred to as the image forming apparatus 10)” in the screen illustrated in FIG. 9. Descriptions of components illustrated in FIG. 10 that are identical to those illustrated in FIGS. 8 and 9 are omitted.

A printer selection prompt 1001 indicates that the selection result is transmitted to the AI server 30 by the user pressing “Printer1” on the printer selection list box 901 illustrated in FIG. 9.

A print setting box 1002 is displayed by the AI server business application plug-in 703 to cause the user to designate print settings. The print setting box 1002 is displayed when the AI server 30 and the extension application server 40 that have received the printer selection result return a response to request print settings. On the print setting box 1002, settings that are the same as those for the printer driver 704 are displayed as default settings. The AI server business application plug-in 703 obtains print setting values that have been set by the printer driver 704 and registered in the HDD 210, and displays the print setting values on the chat area 803.

A number-of-copies setting box 1003 is a box for setting the number of copies to be printed, and the user can arbitrarily set the number of copies by operating upper and lower triangular buttons.

A layout box 1004 is a box for setting a layout of a print product. When the user presses a triangular button on the layout box 1004, a drop-down list (not illustrated) is displayed. The user can thereby set the layout by selecting an option from the displayed list.

A one-sided/double-sided box 1005 is a box for setting one of one-sided printing and double-sided printing for the print product. When the user presses a triangular button on the one-sided/double-sided box 1005, a drop-down list (not illustrated) is displayed. The user can thereby set either one-sided printing or double-sided printing by selecting an option from the displayed list.

A print button 1006 is a button to be pressed to instruct the image forming apparatus 10 to execute printing after print settings are made. When the print button 1006 is pressed, information about the content of each setting item set when the print button 1006 is pressed is transmitted to the AI server 30.

The items that can be displayed and set on the print setting box 1002 are not limited to the items described above. The setting items are not essential items. For example, any other setting items, such as a color/monochrome setting item and a sheet size setting item, can also be set.

The printer selection list box 901 and the print setting box 1002 can also be displayed at once. In this case, the setting for the printer driver 704 varies depending on the printer to be used, so that default values to be displayed can be changed every time the printer to be selected by the user is changed.

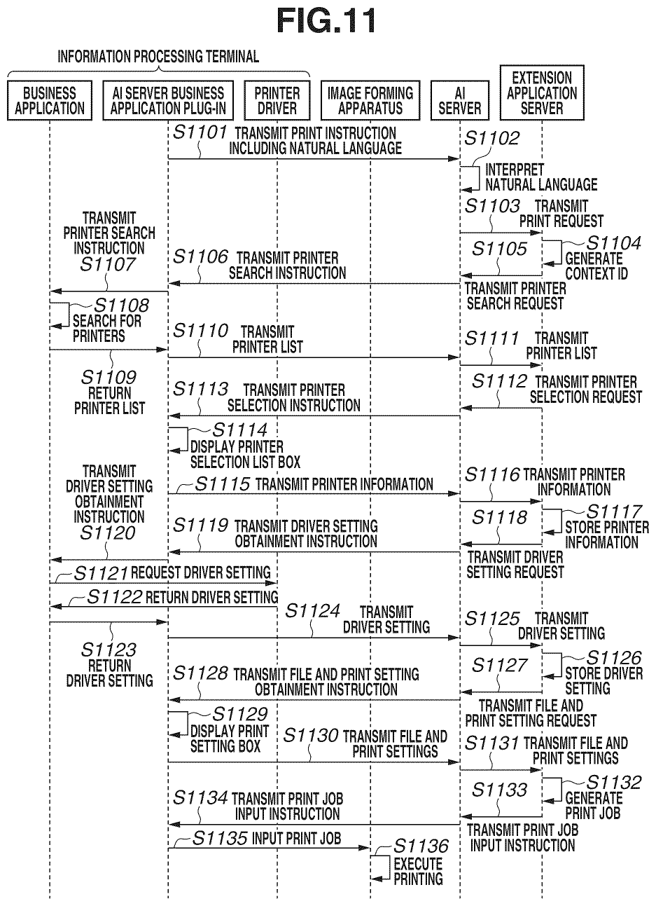

FIG. 11 is a sequence diagram illustrating a sequence of exchanging information among system components from when the user issues a print instruction to the AI server business application plug-in 703 to when a print job is actually input to the image forming apparatus 10.

In step S1101, the CPU 207 of the information processing terminal 20 causes the AI server business application plug-in 703 to operate and causes the AI server 30 to transmit the print start prompt 806. This processing is performed when the above-described prompt transmission button 805 is pressed by the user.

In step S1102, the CPU 301 of the AI server 30 interprets the natural language included in the received print start prompt 806. As a result, the AI server 30 understands that processing requested by the user is printing.

In step S1103, the CPU 301 of the AI server 30 causes the communication unit 304 to transmit a print request to the extension application server 40. This is because information indicating that the function of the extension application server 40 is related to printing is registered in the AI server 30 in advance, thereby enabling the AI server 30 to mediate a request to the appropriate extension application server 40 depending on the request from the user.

In step S1104, the CPU 401 of the extension application server 40 generates a unique identification (ID) (hereinafter referred to as a context ID) for identifying a context in subsequent communication, and stores the generated context ID in the HDD 405. This is because other information processing terminals present on the network 70 may issue a similar print request. Hereinafter, assume that the generated unique ID is added in the communication between the AI server business application plug-in 703 and the AI server 30 and the communication between the AI server 30 and the extension application server 40, unless otherwise described. In the first exemplary embodiment, an expiration period for the context ID is 10 minutes (a long period of time is estimated as a period of time required before a print job is input in the following step), but the expiration period can be changed depending on the situation. The expiration period is not limited to 10 minutes and any period of time can be set. For example, the period can expire when a condition such as a predetermined number of uses is satisfied.

In step S1105, the CPU 401 of the extension application server 40 causes the communication unit 404 to return a printer search request to the AI server 30 so as to identify the printer to be used by the user.

In step S1106, the CPU 301 of the AI server 30 causes the communication unit 304 to return a printer search instruction to the AI server business application plug-in 703.

In step S1107, the CPU 207 causes the AI server business application plug-in 703 to operate and instructs the business application 702 to search for printers.

In step S1108, the business application 702 operated by the CPU 207 searches for printers that can be used by the information processing terminal 20 on the network 70 via the OS 701.

In step S1109, the business application 702 operated by the CPU 207 returns a printer list obtained as a search result to the AI server business application plug-in 703.

In step S1110, the AI server business application plug-in 703 operated by the CPU 207 transmits the printer list to the AI server 30.

In step S1111, the CPU 301 of the AI server 30 causes the communication unit 304 to transmit the printer list to the extension application server 40.

In step S1112, the extension application server 400 operated by the CPU 401 returns a printer selection request to the AI server 30. The printer selection request includes a printer selection list generated based on the received printer list.

In step S1113, the CPU 301 of the AI server 30 causes the communication unit 304 to return a printer selection instruction to the AI server business application plug-in 703. The printer selection instruction includes the printer selection list.

In step S1114, the AI server business application plug-in 703 operated by the CPU 207 displays the above-described printer selection list box 901 and receives selection (pressing of an option) by the user. Specifically, a plurality of printing apparatuses is displayed on the chat area 803, thereby presenting candidates for the printing apparatus to be used for printing.

In step S1115, the AI server business application plug-in 703 operated by the CPU 207 transmits printer information selected by the user to the AI server 30.

In step S1116, the CPU 301 of the AI server 30 causes the communication unit 304 to transmit the printer information to the extension application server 40.

In step S1117, the CPU 401 of the extension application server 40 stores the received printer information associated with the context ID in the HDD 405.

In step S1118, the CPU 401 of the extension application server 40 causes the communication unit 404 to return a driver setting request to the AI server 30.

In step S1119, the CPU 301 of the AI server 30 causes the communication unit 304 to return a driver setting obtainment instruction to the AI server business application plug-in 703.

In step S1120, the AI server business application plug-in 703 operated by the CPU 207 instructs the business application 702 to obtain a driver setting.

In step S1121, the business application 702 operated by the CPU 207 requests the current driver setting from the printer driver 704. The current driver setting is referred to as print setting values registered to be displayed as a default setting at start-up of the printer driver 704. As the default setting values, optional print settings made by the user from a setting screen (not illustrated) can be used. As the current driver setting, a print setting value registered as a bookmark by the user can be used instead of the default setting. If there is a plurality of print setting values registered as a bookmark by the user, the print setting value preliminarily selected by the user from the plurality of print setting values can be used as the default setting value.

In step S1122, the printer driver 704 operated by the CPU 207 returns the current driver setting to the business application 702.

In step S1123, the business application 702 operated by the CPU 207 returns the driver setting to the AI server business application plug-in 703.

In step S1124, the AI server business application plug-in 703 operated by the CPU 207 transmits the driver setting to the AI server 30.

In step S1125, the CPU 301 of the AI server 30 causes the communication unit 304 to transmit the driver setting to the extension application server 40.

In step S1126, the extension application server 40 operated by the CPU 207 stores the received driver setting associated with the context ID in the HDD 405.

In step S1127, the CPU 401 of the extension application server 40 causes the communication unit 404 to return a file to be printed and a print setting request to the AI server 30. This response includes default print settings based on the stored driver setting.

In step S1128, the CPU 301 of the AI server 30 causes the communication unit 304 to return the file and a print setting obtainment instruction to the AI server business application plug-in 703. This response includes default print settings.

In step S1129, the AI server business application plug-in 703 operated by the CPU 207 displays the above-described print setting box 1002 and receives a print setting operation and a print instruction (pressing of the print button 1006) from the user.

In step S1130, the AI server business application plug-in 703 operated by the CPU 207 transmits the file to be printed (document that is currently opened on the business application 702) and print settings to the AI server 30.

In step S1131, the CPU 301 of the AI server 30 causes the communication unit 304 to transmit the file to be printed and print settings to the extension application server 40.

In step S1132, the CPU 401 of the extension application server 40 generates a print job based on the received file to be printed and print settings.

In step S1133, the CPU 401 of the extension application server 40 causes the communication unit 404 to return a print job input instruction to the AI server 30. This instruction includes the printer information stored in step S1117 and the generated print job.

In step S1134, the CPU 301 of the AI server 30 causes the communication unit 304 to return the print job input instruction to the AI server business application plug-in 703. The print job input instruction includes the printer information and the print job.

In step S1135, the AI server business application plug-in 703 operated by the CPU 207 identifies the printer (corresponding to the image forming apparatus 10 in this case) to which the print job is input based on the printer information received in step S1134, and inputs the print job.

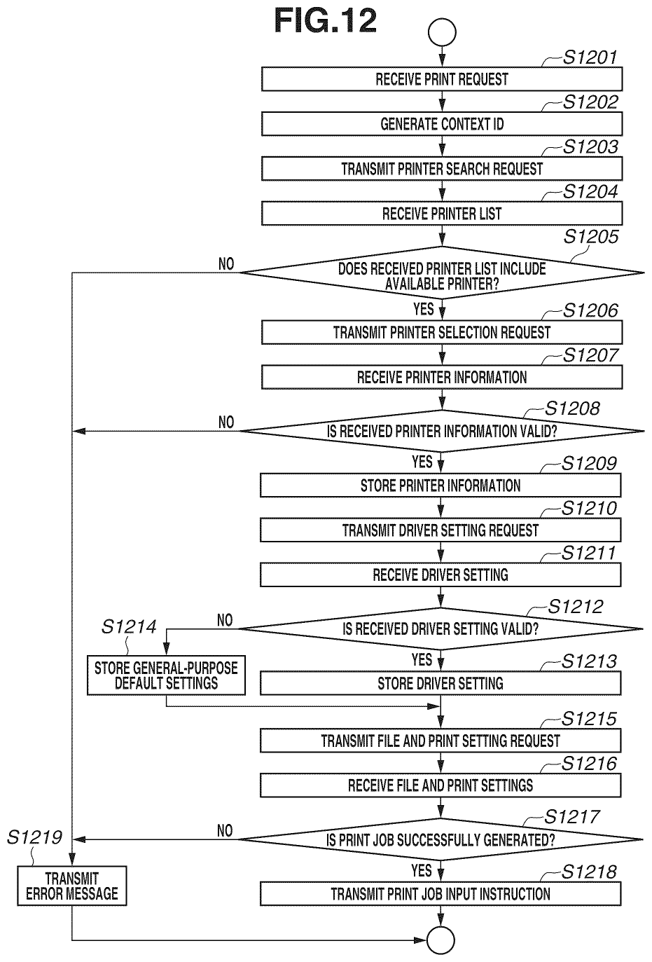

FIG. 12 is a flowchart for the extension application server 40 according to the first exemplary embodiment. The CPU 401 loads programs stored in the ROM 402 into the RAM 403 and executes the programs to thereby execute processing in the flowchart of FIG. 12.

In step S1201, the CPU 401 receives a print request from the AI server 30 (corresponding to step S1103).

In step S1202, the CPU 401 generates a unique context ID and stores the generated context ID in the HDD 405 (corresponding to step S1104).

In step S1203, the CPU 401 causes the communication unit 404 to transmit a printer search request to the AI server 30 (corresponding to step S1105).

In step S1204, the CPU 401 receives a printer list from the AI server 30 (corresponding to step S1111).

In step S1205, the CPU 401 determines whether the received printer list includes an available printer. If it is determined that the received printer list includes an available printer (YES in step S1205), the processing proceeds to step S1206. If it is determined that the received printer list does not include an available printer (NO in step S1205), the processing proceeds to step S1219.

In step S1206, the CPU 401 causes the communication unit 404 to transmit a printer selection request to the AI server 30 (corresponding to step S1112).

In step S1207, the CPU 401 receives printer information from the AI server 30 (corresponding to step S1116).

In step S1208, the CPU 401 determines whether the received printer information is valid. Examples of invalid information include information about a printer that is not covered by the extension application server 40. If the received printer information is valid (YES in step S1208), the processing proceeds to step S1209. If the received printer information is invalid (NO in step S1208), the processing proceeds to step S1219.

In step S1209, the CPU 401 associates the received printer information with the context ID and stores the received printer information associated with the context ID in the HDD 405 (corresponding to step S1117).

In step S1210, the CPU 401 causes the communication unit 404 to transmit a driver setting request to the AI server 30 (corresponding to step S1118).

In step S1211, the CPU 401 receives the driver setting from the AI server 30 (corresponding to step S1125).

In step S1212, the CPU 401 determines whether the received driver setting is valid. Examples of an invalid driver setting include a setting for a driver that is not covered by the extension application server 40. If the received driver setting is valid (YES in step S1212), the processing proceeds to step S1213. If the received driver setting is invalid (NO in step S1212), the processing proceeds to step S1214.

In step S1213, the CPU 401 associates the received driver setting with the context ID and stores the received driver setting associated with the context ID in the HDD 405 (corresponding to step S1126).

In step S1214, the CPU 401 associates general-purpose default settings with the context ID and stores the general-purpose default settings associated with the context ID in the HDD 405 (corresponding to step S1126).

In step S1215, the CPU 401 causes the communication unit 404 to transmit a file to be printed and a print setting request to the AI server 30 (corresponding to step S1127). The contents that are caused to be transmitted by the CPU 401 in step S1215 include default print settings based on the stored setting.

In step S1216, the CPU 401 receives the file to be printed and print settings from the AI server 30 (corresponding to step S1131).

In step S1217, the CPU 401 determines whether a print job is successfully generated based on the received file to be printed and print settings (corresponding to step S1132). If the print job is successfully generated (YES in step S1217), the processing proceeds to step S1218. If the print job is not successfully generated (NO in step S1217), the processing proceeds to step S1219.

In step S1218, the CPU 401 causes the communication unit 404 to transmit a print job input instruction to the AI server 30 (corresponding to step S1133). The print job input instruction includes the printer information stored in step S1209 and the generated print job. After the transmission, the CPU 401 deletes the context ID and all information associated with the context ID.

The processing of step S1219 is error message transmission processing to be performed by the CPU 401 when processing is unsuccessful somewhere in the series of processing associated with the same context ID. After the transmission, the CPU 401 deletes the context ID and all information associated with the context ID.

As described above, according to the first exemplary embodiment, the use of only an instruction using a natural language and a slight operation makes it possible to print a file opened on the business application 702. In this case, the previous print settings can automatically be carried over.

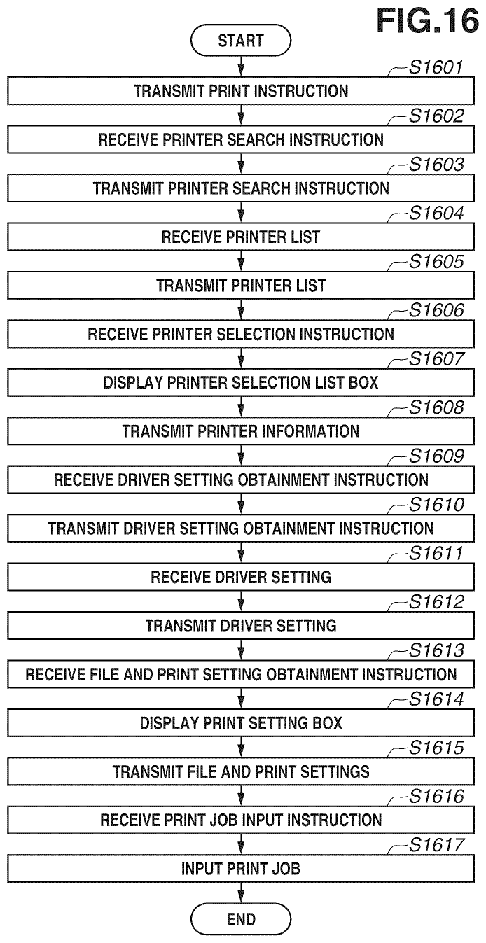

FIG. 16 is a flowchart illustrating an example of processing to be performed by the AI server business application plug-in 703 according to the first exemplary embodiment. The CPU 207 loads programs stored in the ROM 208 into the RAM 209 and executes the programs, thereby executing the processing in the flowchart of FIG. 16.

In step S1601, the CPU 207 detects that the prompt transmission button 805 is pressed by the user. The CPU 207 causes the network communication unit 211 to transmit, to the AI server 30, the prompt input to the AI server business application prompt input area 804 when the prompt transmission button 805 is pressed (corresponding to step S1101). Specifically, in a case where the print start prompt 806 is input by the user, the print instruction from the user is transmitted to the AI server 30.

In step S1602, the CPU 207 receives a printer search instruction from the AI server 30 (corresponding to step S1106).

In step S1603, the CPU 207 transmits the printer search instruction received in step S1602 to the business application 702 from the AI server business application plug-in 703 (corresponding to step S1107).

In step S1604, the AI server business application plug-in 703 operated by the CPU 207 receives a printer list from the business application 702 (corresponding to step S1109).

In step S1605, the CPU 207 causes the network communication unit 211 to transmit the printer list received in step S1604 to the AI server 30 (corresponding to step S1110).

In step S1606, the CPU 207 receives a printer selection instruction from the AI server 30 (corresponding to step S1113).

In step S1607, the CPU 207 causes the operation panel 201 of the information processing terminal 20 to display the printer selection list box 901, and detects selection (pressing of an option) performed by the user (corresponding to step S1114). In other words, when the CPU 207 detects selection performed by the user, the CPU 207 can receive information about the printer to be used for the user to execute printing. In step S1608, the CPU 207 causes the network communication unit 211 to transmit the printer information received in step S1607 to the AI server 30 (corresponding to step S1115).

In step S1609, the CPU 207 receives a driver setting obtainment instruction from the AI server 30 (corresponding to step S1119).

In step S1610, the CPU 207 transmits the driver setting obtainment instruction received in step S1609 to the business application 702 from the AI server business application plug-in 703 (corresponding to step S1120).

In step S1611, the AI server business application plug-in 703 operated by the CPU 207 receives a driver setting from the business application 702 (corresponding to step S1123).

In step S1612, the CPU 207 causes the network communication unit 211 to transmit the driver setting received in step S1611 to the AI server 30 (corresponding to step S1124).

In step S1613, the CPU 207 receives a file and a print setting obtainment instruction from the AI server 30 (corresponding to step S1128).

In step S1614, the CPU 207 causes the operation panel 201 of the information processing terminal 20 to display the print setting box 1002. The CPU 207 detects an operation on the print setting box 1002 and pressing of the print button 1006 performed by the user (corresponding to step S1129). In other words, when the CPU 207 detects an operation on the print setting box 1002 and pressing of the print button 1006 performed by the user, the CPU 207 can receive the print settings and the print instruction from the user.

In step S1615, the CPU 207 causes the network communication unit 211 to transmit, to the AI server 30, the file to be printed (document that is currently opened on the business application 702) and the print settings received in step S1614 (corresponding to step S1130).

In step S1616, the CPU 207 receives a print job input instruction including printer information and a print job from the AI server 30 (corresponding to step S1134).

In step S1617, the CPU 207 causes the network communication unit 211 to transmit the print job received in step S1616 to the image forming apparatus 10 (corresponding to step S1135). In this case, the CPU 207 transmits the print job to the printer (image forming apparatus 10) corresponding to the printer information received in step S1616. After completion of this step, the CPU 207 terminates this processing.

According to the first exemplary embodiment as described above, it is possible to reduce time and effort for the user to make print settings when the user issues a print instruction in a chat format.

A method of printing using a cloud print server without installing a printer driver on an information processing terminal has recently been in widespread use. A second exemplary embodiment illustrates a configuration example where a cloud print server is added to the system configuration according to the first exemplary embodiment.

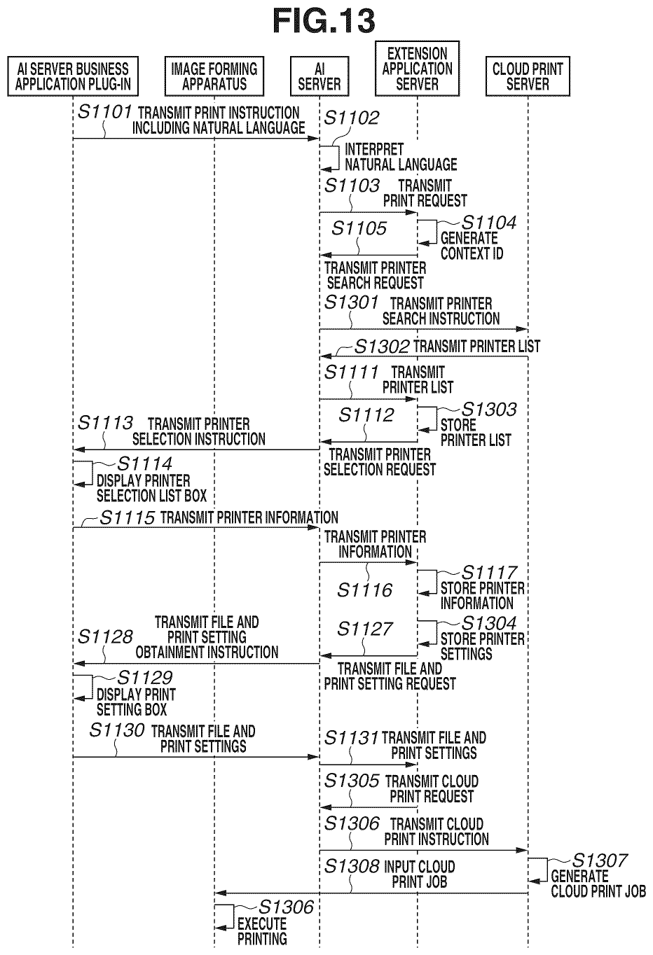

FIG. 13 is a sequence diagram based on the sequence diagram in FIG. 11, and illustrates a derivative sequence for the configuration including the cloud print server 50. Descriptions of processes identical to those in FIG. 11 will be omitted, and only information exchange processing that is specific to the second exemplary embodiment will be described. Further, secure information for identifying each user based on user account information is constantly added in the communication between the AI server business application plug-in 703 and the AI server 30 and the communication between the AI server 30 and the cloud print server 50, unless otherwise described. With this configuration, each information processing apparatus can obtain information associated with the user.

In step S1301, the CPU 301 of the AI server 30 causes the communication unit 304 to transmit a printer search instruction to the cloud print server 50.

In step S1302, the CPU 501 of the cloud print server 50 causes the communication unit 504 to return a printer list associated with the user to the AI server 30. In this case, information about each printer includes default print settings.

In step S1303, the CPU 401 of the extension application server 40 associates the received printer list with the context ID and stores the received printer list associated with the context ID in the HDD 405.

In step S1304, the CPU 401 of the extension application server 40 stores default print settings for the printer selected by the user in step S1114 in the HDD 405. The default print settings for the printer are obtained from the information in the printer list stored in step S1303.

In step S1305, the CPU 401 of the extension application server 40 causes the communication unit 404 to return a cloud print request to the AI server 30. The cloud print request includes printer information, but does not include a print job, unlike the print job input instruction returned in step S1134. The cloud print request includes a file to be printed and print setting information in place of a print job. This is because, in the second exemplary embodiment using the cloud print server 50, the cloud print server 50 has a print job generation function.

In step S1306, the CPU 30 of the AI server 30 causes the communication unit 304 to transmit a cloud print instruction to the cloud print server 50. The cloud print instruction includes printer information, a file to be printed, and print setting information.

In step S1307, the CPU 501 of the cloud print server 50 generates a print job based on the received file to be printed and print settings.

In step S1308, the CPU 501 of the cloud print server 50 identifies the printer (corresponding to the image forming apparatus 10 in this case) to which the print job is input based on the printer information received in step S1306, and inputs a cloud print job.

As described above, according to the second exemplary embodiment, the use of only an instruction using a natural language and a slight operation makes it possible to print a file opened on the business application 702 even in a case where the cloud print server 50 is used without installing a printer driver. In this case, default print settings for the printer registered in the cloud print server 50 can be automatically carried over.

A third exemplary embodiment illustrates an example where the print job generation function implemented by the extension application server 40 according to the first exemplary embodiment is implemented by a job generation server 140 instead of the extension application server 40. In the third exemplary embodiment, the job generation server 140 (not illustrated) is added as a component to the entire configuration of the AI print service (FIG. 1). The job generation server 140 is a server having the functions of the extension application server 40, excluding the printer-related functions of the extension application server 40.

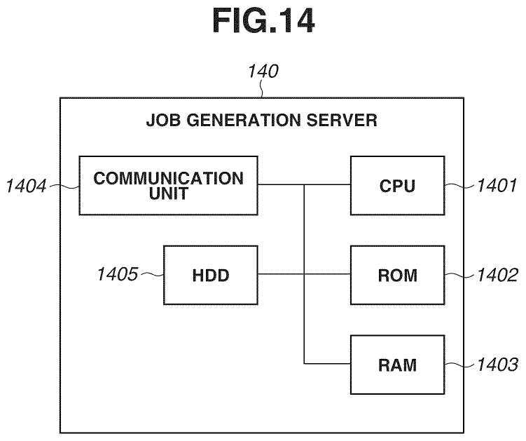

FIG. 14 is a block diagram illustrating a hardware configuration example of the job generation server 140. A CPU 1401 executes processing for controlling an operation of generating an appropriate response by using a control program stored in a ROM 1402 and a learning model stored in an HDD 1405. The ROM 1402 stores control programs. A RAM 1403 is used as a main memory and a temporary storage area such as a work area for the CPU 1401. The HDD 1405 stores various data such as a learning model and an AI application. The job generation server 140 can transmit and receive data with various apparatuses such as the information processing terminal 20, the image forming apparatus 10, and the extension application server 40 via a communication unit 1404. The communication unit 1404 can establish wired communication using Ethernet®, or can establish wireless communication such as Wi-Fi®.

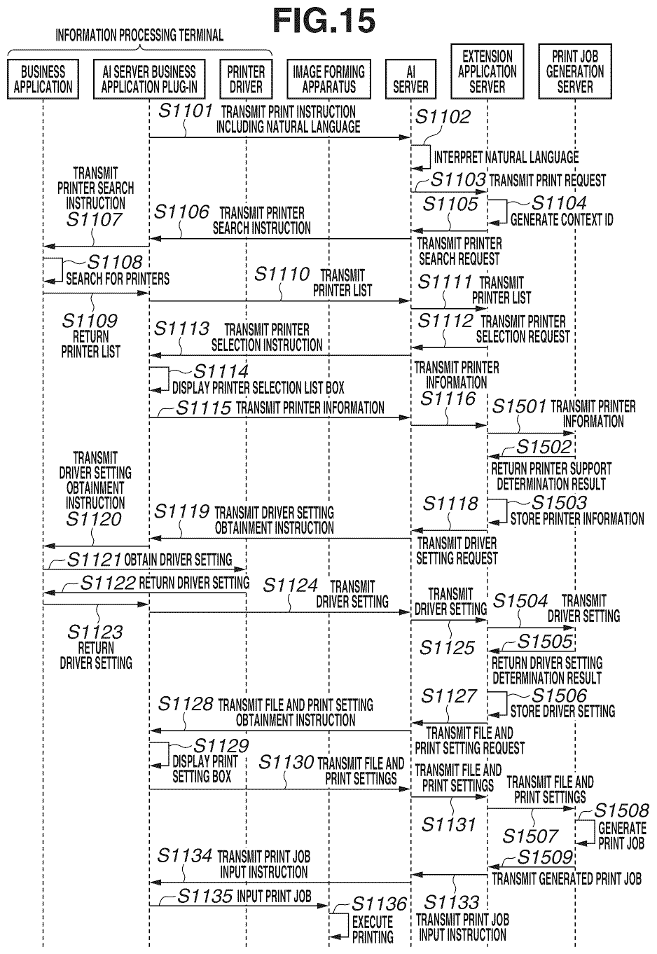

FIG. 15 is a sequence diagram based on the sequence diagram of FIG. 11 and illustrates a derivative sequence for a configuration in which the print job generation function implemented by the extension application server 40 is implemented by the dedicated job generation server 140 instead of the extension application server 40. Descriptions of steps illustrated in FIG. 15 that are identical to those illustrated in FIG. 11 will be omitted and only information exchange processing that is specific to the third exemplary embodiment will be described.

In step S1501, the CPU 401 of the extension application server 40 causes the communication unit 404 to transmit printer information to the job generation server 140.

In step S1502, the CPU 1401 of the job generation server 140 determines whether the received printer information is valid and causes the communication unit 1404 to return the determination result to the extension application server 40. The processing of step S1502 is processing in which the processing performed by the extension application server 40 in step S1208 is performed and transferred to the job generation server 140.

In step S1503, in a case where the received determination result indicates valid information, the CPU 401 of the extension application server 40 associates the printer information received in step S1116 with the context ID and stores the printer information associated with the context ID in the HDD 405. In a case where the received determination result indicates invalid information, the CPU 401 performs the processing of step S1219 and then terminates the processing in this flowchart.

In step S1504, the CPU 401 of the extension application server 40 causes the communication unit 404 to transmit a driver setting to the job generation server 140.

In step S1505, the CPU 1401 of the job generation server 140 causes the communication unit 1404 to return a result of determination as to whether the received driver setting is valid to the extension application server 40. The processing of step S1505 is processing in which the processing performed by the extension application server 40 in step S1212 is performed and transferred to the job generation server 140.

In step S1506, in a case where the received determination result indicates that the driver setting is valid, the CPU 401 of the extension application server 40 associates the driver setting received in step S1125 with the context ID and stores the driver setting associated with the context ID in the HDD 405. In a case where the received determination result indicates that the driver setting is invalid, the CPU 401 associates and stores general-purpose default settings with the context ID.

In step S1507, the CPU 401 of the extension application server 40 causes the communication unit 404 to transmit a file to be printed and print settings to the job generation server 140.

In step S1508, the CPU 1401 of the job generation server 140 generates a print job based on the received file to be printed and print settings.

In step S1509, the CPU 1401 of the job generation server 140 causes the communication unit 1404 to return the print job generated in step S1508 to the extension application server 40.

As described above, according to the third exemplary embodiment, the extension application server 40 can serve to mediate information between the AI server 30 and the job generation server 140, while the job generation server 140 can serve to perform printer-related dedicated processing.

Other examples of the printer driver described herein can include a scanner driver. Settings for scanning can be registered with a scanner driver. During scanning, a one-sided/double-sided scanning setting or a scanning resolution setting registered by a CPU can be called and displayed, and the user can make a scanning setting by selecting one of the settings from the displayed settings.

Combinations of pieces of software and servers described herein are not limited to the examples described above. For example, the business application 702 and the AI server business application plug-in 703 included in the information processing terminal 20 need not necessarily be separate from each other, and the same software can be used to carry out the present disclosure. For example, the present disclosure can be carried out by sharing the functions of the AI server business application plug-in 703 by a plurality of pieces of software. Similarly, the AI server 30, the extension application server 40, and the cloud print server 50, which are separate from each other as described above, need not necessarily be separate from each other, and the present disclosure can be carried out using one server. The number and combinations of the AI servers 30, the extension application servers 40, and the cloud print servers 50 can be arbitrarily set.

The present disclosure can also be implemented by processing in which a program for implementing one or more functions according to the above-described exemplary embodiments is supplied to a system or an apparatus via a network or a storage medium, and one or more processors in a computer of the system or the apparatus read out and execute the program. The present disclosure can also be implemented by a circuit (e.g., an ASIC) for implementing one or more functions according to the exemplary embodiments.

According to an aspect of the present disclosure, it is possible to reduce time and effort for a user to make print settings when the user issues a print instruction in a chat format.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-077930, filed May 13, 2024, which is hereby incorporated by reference herein in its entirety.

What is claimed is:

1. A non-transitory computer-readable storage medium for storing a program for causing a computer of an information processing apparatus to perform an information processing method, the method comprising:
receiving a print instruction using a chat function;
obtaining a print setting registered by a printer driver included in the information processing apparatus; and
causing a printing apparatus to perform printing based on the print setting according to the print instruction.

2. The non-transitory computer-readable storage medium according to claim 1, the method further comprising displaying the obtained print setting on a chat area for exchanging a message with the chat function.

3. The non-transitory computer-readable storage medium according to claim 2, wherein the print instruction is received after the print setting is displayed.

4. The non-transitory computer-readable storage medium according to claim 2, wherein the chat area and data to be printed are displayed side by side within one window.

5. The non-transitory computer-readable storage medium according to claim 4, wherein the chat function is called by an application program for editing the data to be printed.

6. The non-transitory computer-readable storage medium according to claim 2, the method further comprising changing the displayed print setting according to a user instruction,
wherein the printing apparatus is caused to perform printing based on the changed print setting.

7. The non-transitory computer-readable storage medium according to claim 1, wherein the print setting is registered as a print setting to be displayed as a default setting at start-up of the printer driver according to a user instruction.

8. The non-transitory computer-readable storage medium according to claim 1, wherein the print setting is registered as a print setting for a bookmark function of the printer driver according to a user instruction.

9. The non-transitory computer-readable storage medium according to claim 1, wherein the print instruction input by a user using characters of a natural language is received using the chat function.

10. The non-transitory computer-readable storage medium according to claim 1, the method further comprising:
receiving information about a plurality of printing apparatuses;
presenting the plurality of printing apparatuses on a chat area for exchanging a message with the chat function based on the received information; and
selecting the printing apparatus from the plurality of printing apparatuses presented on the chat area according to a user instruction.

11. A control method for controlling an information processing apparatus, comprising:
receiving a print instruction using a chat function;
obtaining a print setting registered by a printer driver included in the information processing apparatus; and
instructing a printing apparatus to perform printing based on the print setting according to the print instruction.

12. The control method according to claim 11, further comprising displaying the obtained print setting on a chat area for exchanging a message with the chat function.

13. The control method according to claim 12, wherein the print instruction is received after the print setting is displayed.

14. The control method according to claim 12, wherein the chat area and data to be printed are displayed side by side within one window.

15. The control method according to claim 14, wherein the chat function is called by an application program for editing the data to be printed.

16. The control method according to claim 12, further comprising changing the displayed print setting according to a user instruction,
wherein the printing apparatus is instructed to perform printing based on the changed print setting.

17. The control method according to claim 11, wherein the print setting is registered as a print setting to be displayed as a default setting at start-up of the printer driver according to a user instruction.

18. The control method according to claim 11, wherein the print setting is registered as a print setting for a bookmark function of the printer driver according to a user instruction.

19. The control method according to claim 11, wherein the print instruction input by a user using characters of a natural language is received using the chat function.

20. An information processing apparatus comprising:
at least one memory storing a program; and
at least one processor that executes the stored program, which cause the at least one processor to:
receive a print instruction using a chat function;
obtain a print setting registered by a printer driver included in the information processing apparatus; and
instruct a printing apparatus to perform printing based on the print setting according to the print instruction.
